(19) United States
(12) Patent Application Publication
(10) Pub. No.: US 2003/0029628 A1
(43) Pub. Date: Feb. 13, 2003

(54) Electrical line and process for producing the same

(75) Inventors: Joachim Uttinger, Kalchreuth (DE); Ferdinand Groegl, Nuerenberg (DE); Stefan Otto, Weissenohe (DE)

Correspondence Address: SUGHRUE MION, PLLC, 2100 Pennsylvania Avenue, NW, Washington, DC, 20037-3213, US

(73) Assignee: NEXANS

(21) Appl. No.: 10/266,759

(22) Filed: Oct. 9, 2002

Related U.S. Application Data
(62) Division of application No. 10/011,714, filed on Dec. 11, 2001.

(30) Foreign Application Priority Data
Dec. 20, 2000 (DE) 10063542.3

(51) Int. Cl. H01B 9/02

(52) U.S. Cl. 174/106 R

(57) ABSTRACT

An electrical line (L) with at least one electrical conductor (1) surrounded by an insulation (2) in which a braid (4) of metallic wires serving for electrical shielding is disposed over the insulation (2), and a jacket (6) of an insulating material is applied over the braid (4). To produce a shield that is effective even at very high frequencies, the insulation (2), which is made of a heat-resistant material, is first covered all around with a closed metallic sheath (3) produced by vapor deposition. The braid (4) is then applied to the sheath (3) in direct contact therewith and, in addition, the braid (4) is covered all around with a metallic coating (5) produced in a coating process.

This application is based on and claims the benefit of German Patent Application No. 100 63 542.3 filed Dec. 20, 2000, which is incorporated by reference herein.

### BACKGROUND OF THE INVENTION

The invention relates to an electrical line with at least one electrical conductor surrounded by an insulation, in which a braid of metallic wires serving as electrical shielding is arranged over the insulation and a sheath of insulating material is arranged over the braid, as well as to a process for producing such an electrical line, e.g., as disclosed in German Laid Open Application DE-OS 25 25 149.

Such lines are generally used whenever signals have to be transmitted without interference. On the one hand it must be ensured that transmission on the line is not affected by external interference fields, and on the other hand that the line itself does not produce interference fields. In the aforementioned DE-OS 25 25 149, this is achieved only with reservations. The braid of copper wires, which is used here for shielding, is not sufficiently tight, even if executed carefully and if the degree of coverage is high.

### SUMMARY OF THE INVENTION

The object of the invention is to improve the shield of the above-described line so as to ensure interference-free operation even at very high frequencies. This object is attained according to the invention by an electrical line wherein:

the insulation, which is made of a heat resistant material, is covered all around by a closed metallic sheath produced by vapor deposition,

the braid is applied to said sheath in direct contact therewith, and

in addition, the braid is completely enclosed with a metallic layer produced in a coating process.

This line, similar to a coaxial high-frequency cable with a tubular, closed outer conductor, has a metallic layer in the vapor deposited sheath, which is closed all around. As a result, it is electrically completely tight even at very high frequencies. The sheath adheres to the insulation and ensures complete shielding in its intact state. It is very thin with a correspondingly small conducting cross section and is therefore mechanically sensitive. The braid, which is applied directly to the sheath, serves not only as a mechanical support therefor, but together with the sheath forms the necessary conducting cross section for carrying currents and for securely connecting contact elements. In addition, due to the interaction between sheath and braid, the transverse conductivity of the shield is increased, so that attenuation losses are reduced. The additionally applied metallic layer results in another layer that is closed all around, by which the line is furthermore made moisture proof. Moreover, any possible gaps in the shield, such as pores in the sheath, are covered by the metal. Since the insulation of the conductor is made of a heat resistant material, the line is also suitable for higher power signal transmission in the high-frequency range. The line is flexible as a whole.

### BRIEF DESCRIPTION OF THE DRAWINGS

An exemplary embodiment of the subject of the invention is depicted in the drawings, in which

FIG. 1 is a schematic representation of a line according to the invention with partly cutaway layers,

FIG. 2 is a similar schematic representation of an arrangement for manufacturing the line according to the invention.

### DETAILED DESCRIPTION OF THE INVENTION

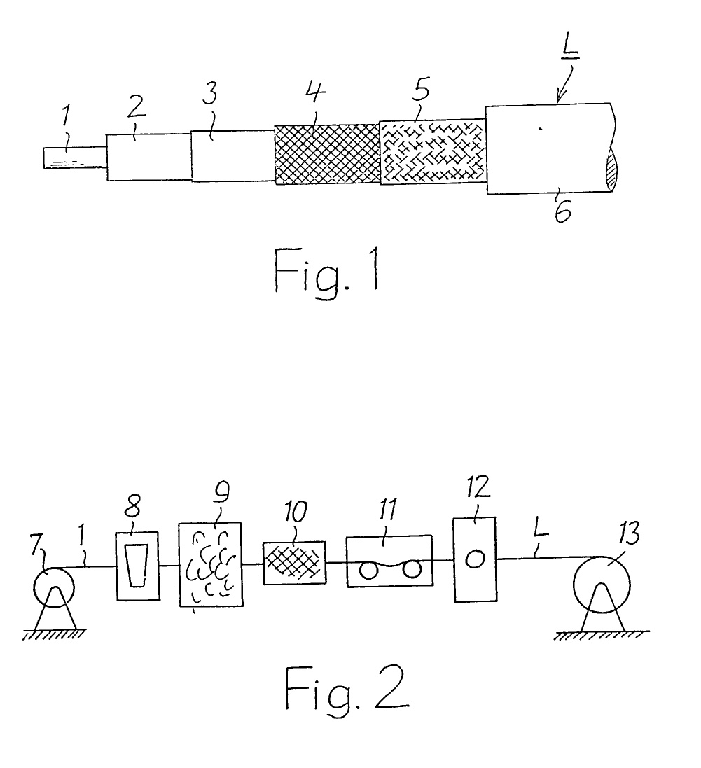

The shielded electrical line L shown in FIG. 1 is suitable, for instance, as a line for antennas in mobile radio communications. It preferably has a conductor 1 made of silver-plated copper, which is surrounded by insulation 2 made of a heat-resistant material. A suitable material, for instance, is polytetrafluoroethylene (PTFE), which can be used up to temperatures of about 250° C. Metallic sheath 3, which is closed all around and has a wall thickness of 1 μm to 3 μm, is disposed over insulation 2. It is made, for example, of copper, silver or gold. The material of sheath 3 is applied to insulation 2 in a vapor deposition process and adheres to its surface.

A braid 4, which is preferably made of silver- or tin-plated copper wires, is placed around sheath 3, in direct contact thereto. It is applied with a high coverage factor of more than 90%. Braid 4 is surrounded by a closed metallic layer, preferably a tin layer 5, which is applied in a tin bath 11 (FIG. 2). A jacket 6 of insulating material, which is applied over the coated braid 4, is made of a fluoropolymer as a heat resistant material, preferably fluoroethylenepropylene (FEP). Jacket 6 can also be made of sintered PTFE and can be produced, for example, by wound-up foils.

Line L according to the invention is manufactured, for example, as follows:

Conductor 1 made of silver-plated copper is pulled off a reel 7 and delivered to a unit 8 for applying insulation 2 made of PTFE. This material is applied to conductor 1 by the known technique of RAM extrusion. Thereafter, the insulated conductor 1 passes through a chamber 9, which contains a coating metal in the vapor phase, preferably silver. In chamber 9, the metallic sheath 3, which is closed all around, is applied to insulation 2 with a wall thickness ranging between 1 μm and 3 μm.

After sufficient hardening of the material of sheath 3, braid 4 of silver-plated copper wires is applied to the sheath in a braider with about 90% coverage. Line L then passes through a tin bath 11 in which the fully closed tin layer 5 is produced. Tin layer 5 not only completely covers braid 4, but also closes any possible openings that may have remained in the previously produced shield. These may, for instance, be pores in sheath 3. After that, line L is provided with a fully effective shield for high frequencies in the GHz range. It is heat resistant due to insulation 2, which is made of PTFE, and also sufficiently flexible due to braid 4. Finally, jacket 6 made of FEP is applied over the tin-plated braid 4 in an extruder 12. The finished line L can then be taken up by a coil 13 or be supplied directly to a further processing unit.

The metals and insulation materials mentioned above should be understood only as examples. Conductor 1 can also be made of some other good conductive material, for instance non-silver-plated copper. Other heat-resistant materials besides the indicated PTFE and FEP can be used for insulation 2 and jacket 6. Jacket 6 can, for instance, be made of polyimide, which is applied in the form of foils and bonded by heat treatment. The tin layer 15 produced in tin bath 11 can be replaced, for instance, by a silver layer produced by vapor deposition.

What is claimed is:

1. an electrical line with at least one electrical conductor surrounded by an insulation, in which a braid of metallic wires serving for electrical shielding is arranged over the insulation, and in which a jacket of an insulating material is applied over the braid, characterized in that
the insulation (2) is made of a heat resistant material and is substantially entirely covered by a metallic sheath (3) produced by vapor deposition,
the braid (4) is applied to the sheath (3) in direct contact therewith, and
in addition, the braid (4) is substantially completely covered with a metallic layer produced in a coating process.

2. A line as claimed in claim 1, characterized in that the insulation (2) of the line (1) is made of polytetrafluoroethylene.

3. A line as claimed in claim 1, characterized in that the sheath (3) is made of copper.

4. A line as claimed in claim 1, characterized in that the sheath (3) is made of silver.

5. A line as claimed in claim 1, characterized in that the sheath (3) is made of gold.

6. A line as claimed in claim 1, characterized in that the metallic layer is a tin layer (15) produced in a tin bath (11).

7. A line as claimed in claim 1, characterized in that the metallic layer is a silver layer produced by vapor deposition.

8. A line as claimed in claim 1, characterized in that the braid (4) is made of copper.

9. A line as claimed in claim 1, characterized in that the braid (4) is made of silver-plated copper.

10. A line as claimed in claim 1, characterized in that the jacket (6) is made of a fluoropolymer.

11. A line as claimed in claim 10, characterized in that the jacket (6) is made of fluoroethylenepropylene.

12. A line as claimed in claim 10, characterized in that the jacket (6) is made of sintered polytetrafluoroethylene, preferably from a wound-up foil.

13. A line as claimed in claim 1, characterized in that the jacket (6) is made of polyimide.

14. A process for producing a shielded electrical line with at least one electrical conductor surrounded by an insulation of heat resistant material, a metallic sheath substantially entirely covers said insulation, a braid of metallic wires serving for electrical shielding is arranged over the insulation and in direct contact therewith, the braid is substantially completely covered with a metallic layer produced in a coating process, and a jacket of an insulating material is applied thereover, said method comprising the steps of:
applying said insulation (2) made of a heat resistant material all around said electrical conductor (1),
vapor depositing said metallic sheath (3) all around the insulation (2),
applying said braid (4) of copper wires to the sheath (3),
applying a thin metallic layer all around the braid (4), and
applying said jacket (6) to the coated braid (4).

15. A process as claimed in claim 14, characterized in that line (L) provided with the braid (4) is pulled through a tin bath (11) to produce the metallic layer.
